(19) United States
(12) Patent Application Publication
(10) Pub. No.: US 2024/0387838 A1
(43) Pub. Date: Nov. 21, 2024

(54) ELECTROCHEMICAL CELL COMPRISING A SEALING ARRANGEMENT

(71) Applicant: Robert Bosch GmbH, Stuttgart (DE)

(72) Inventors: Stefan Schoenbauer, Ditzingen (DE); Erdogan Dikmenli, Neckarwestheim (DE)

(21) Appl. No.: 18/694,048

(22) PCT Filed: Sep. 7, 2022
(86) PCT No.: PCT/EP2022/074825

§ 371 Date: Mar. 21, 2024

(30) Foreign Application Priority Data
Sep. 22, 2021 (DE) 10 2021 210 518.1

(51) Int. Cl. H01M 8/0254; C25B 9/77; C25B 13/02; H01M 8/0276; H01M 8/1004; H01M 8/241

(52) U.S. Cl. CPC H01M 8/0254; C25B 9/77; C25B 13/02; H01M 8/0276; H01M 8/1004; H01M 8/241

(57) ABSTRACT

The invention proposes an electrochemical cell comprising:
a first bipolar plate (101) and a second bipolar plate (102); wherein the first bipolar plate (101) and the second bipolar plate (102) each have a feeding device (150) for feeding operating media from a port connection (140) of the bipolar plate into a feeding region (160) of the respective bipolar plate; and the feeding device of the first bipolar plate (150) is set up to seal a membrane electrode assembly (110), which is arranged between the first bipolar plate (101) and the second bipolar plate (102) with respect to the first bipolar plate (101) by means of an anode seal (154a) arranged on an anode side of the first bipolar plate, and
the feeding device of the second bipolar plate (150) is set up to seal the membrane electrode assembly (110) with respect to the second bipolar plate (102) by means of a cathode seal (154b) on a cathode side of the second bipolar plate; wherein the anode side of the first bipolar plate is set up to position and support the anode seal (154a); and the cathode side of the second bipolar plate is set up to position and support the cathode seal (154b); characterized in that the anode seal and the cathode seal are arranged in a spatially corresponding manner opposite each other, and a contact pressure acting on the membrane electrode assembly (110) is supported by the anode seal (154a) and by the cathode seal (154b) in the feeding device (150) without interruption.

### BACKGROUND

Hydrogen-based fuel cells as an example of electrochemical cells are regarded as the basis for a mobility concept of the future, as they essentially only emit water and enable fast refueling times. Fuel cells are electrochemical energy converters, wherein a plurality of such fuel cells are interconnected to form a fuel cell stack in order to provide a correspondingly high total voltage or total power. The reactants hydrogen (H2) and oxygen (O2) are converted into electrical energy, water (H2O) and heat.

For example, PEM (proton-exchange-membrane) fuel cells can be operated in an electrocatalytic electrode process with the air fed to the cathode of the fuel cell, with oxygen as the oxidizing agent and the hydrogen fed to the anode of the fuel cell as the fuel, in order to provide electrical energy with a high degree of efficiency. Fuel cell systems with PEM fuel cells are already on the market in initial series applications and have great potential to play a significant role in the energy and transportation transition.

### SUMMARY

In electrochemical cells, such as fuel cells and electrolyzers, the operating media, such as the fuel or the oxidizing agent, are separated by a membrane. The cooling medium, as a further operating medium, flows into the bipolar plates (BPP) adjacent to the active electrochemical cells. These bipolar plates can, for example, be made in two parts from metal sheets in the form of, for example, two electrode boards, wherein one of the two electrode boards is assigned to the anode of one electrochemical cell and the other electrode board is assigned to the cathode of a neighboring electrochemical cell.

To feed all fuel cells in the fuel cell stack with the respective operating media, the respective electrode boards of the bipolar plates or the electrochemical cells have openings, which are referred to here as port connections and together form a port in the case of stacked electrochemical cells. These port connections can have circumferential seals to seal against the equipment in the port. To feed the operating fluid from the port into an active region of the respective fuel cell, the operating fluid must pass through this circumferential seal at certain sections of the port connection. This can be done, for example, by breaking the seal. For the fuel cell stack to function properly, the mechanical support effect for corresponding seals on other electrode boards must still be guaranteed at the interrupted point.

If the port connection is sealed with seals arranged on a bulge of a bead, the force exerted by stacked fuel cells can be dissipated via the flanks of the corrugation. The spring effect is provided by the bead. The disadvantage here is that the design of the bead must be extremely precise and tolerances can hardly be compensated. Another disadvantage is that media can flow inside the bead and thus undesirably flow around the active electrochemical cell.

When sealing the port connection with seals arranged in a groove, which is formed in particular by a bead in an electrode board, the thickness of the inserted seals for introducing or passing operating medium, such as a cooling medium, between the bipolar plates in this region of the feedthrough can be reduced according to the prior art, which is disadvantageous because the height of the groove is then reduced at these points.

According to one aspect, an electrochemical cell, a fuel cell stack and a use of an electrochemical cell according to the features of the independent claims are proposed, which solve at least in part the described tasks. Advantageous configurations are the subject matter of the dependent claims and the following description.

According to one aspect, an electrochemical cell comprising a first bipolar plate and a second bipolar plate is proposed, wherein the first bipolar plate and the second bipolar plate each have a feeding device for feeding operating media from a port connection of the respective bipolar plate to a feeding region of the respective bipolar plate. Furthermore, the feeding device of the first bipolar plate may be set up to seal a membrane electrode assembly, which is arranged between the first bipolar plate and the second bipolar plate, from the first bipolar plate (101) by means of an anode seal arranged on an anode side of the first bipolar plate. Furthermore, the feeding device of the second bipolar plate can be set up to seal the membrane electrode assembly by means of a cathode seal on a cathode side of the second bipolar plate relative to the second bipolar plate, wherein the anode side of the first bipolar plate can be set up to position and support the anode seal and the cathode side of the second bipolar plate can be set up to position and support the cathode seal, so that the anode seal and the cathode seal are arranged spatially correspondingly opposite one another, and that a contact pressure acting on the membrane electrode assembly is supported by the anode seal and by the cathode seal in the respective feeding device without interruption.

In this context, uninterrupted support can mean that the respective seal on the side opposite the membrane electrode assembly is supported at each point of the seal by the respective bipolar plate, in particular by an electrode board of the respective bipolar plate.

Such a contact pressure acting on the membrane electrode assembly from the anode seal and from the cathode seal can result in particular when assembling a fuel cell stack formed from a plurality of electrochemical cells or a plurality of bipolar plates.

The term electrochemical cell is to be understood broadly and comprises, for example, fuel cells or electrolyzer cells. Each electrochemical cell has an anode electrode and a cathode electrode, for example in the form of electrode boards.

Since cooling is necessary for the operation of an electrochemical cell, the electrochemical cell can also have a cooling device for both the anode electrode and the cathode electrode in this context. In particular, the electrochemical cell can have a bipolar plate as an anode electrode and/or cathode electrode through which an operating medium such as a coolant flows.

The term operating medium is to be understood broadly and comprises all media that can be used to operate an electrochemical cell. In particular, an operating medium can be a coolant for the operation of the electrochemical cell or a process medium such as an oxidizing agent, such as the oxygen in the air, or a fuel, such as hydrogen gas.

A respective seal can be inserted into a bead or groove or molded onto a respective electrode board of the bipolar plate. Furthermore, the respective seal can be molded onto the membrane electrode assembly and thus connected to the membrane electrode assembly, which can also be supported on an electrode board. Alternatively, the respective seal can be applied by processes such as dispensing or printing.

Because the respective seal is supported without interruption by the one bipolar plate, a respective seal of a further bipolar plate, on a side opposite the membrane electrode assembly, can also be supported without interruption through the membrane electrode assembly in order to improve a respective seal by the seals.

The feeding region of the respective bipolar plate can be used to feed the respective electrochemical cell with the respective operating medium, in particular as a fuel or as an oxidizing agent. Furthermore, the feeding region of the bipolar plate itself can feed a fluid with which the bipolar plate can be tempered.

By the fact that the feeding device is set up to seal the respective bipolar plates to the membrane electrode assembly, a port connection can be formed, with which advantageously, in particular in the assembled state, a sealed port of a stack of such electrochemical cells with membrane electrode assemblies and the bipolar plates can be formed.

A port connection of the electrochemical cell can be a connection with which each individual electrochemical cell, or each individual bipolar plate, of a stack of electrochemical cells, or correspondingly a stack of bipolar plates and membrane electrode assemblies, is fed with the operating media. In the case of stacked electrochemical cells, the individual port connections can together form a channel in the form of a port through the stack and be sealed off from the electrode boards by seals in such a way that the respective operating medium, which is transported in such a channel, can be fed between the respective electrode boards in such a way that the different functional regions of the electrochemical cell are fed with the respective operating medium. A corresponding channel, port or port connection can be provided in a stack of electrochemical cells for discharging the operating media.

In particular, the first bipolar plate can designed to be the same as the second bipolar plate.

Both the feeding device of the first bipolar plate and the feeding device of the second bipolar plate can be fluid-coupled to the port connection and/or, in particular, fluid-coupled to the port of the fuel cell stack.

According to one aspect, it is proposed that the anode seal of the first bipolar plate and the cathode seal of the second bipolar plate are arranged opposite one another in a spatially corresponding manner over their respective entire lengthwise extent, in particular in the feeding device, such that a contact pressure of the anode seal acting on the membrane electrode assembly is supported by the cathode seal.

As a result, a force acting on the membrane electrode assembly from the anode seal of the first bipolar plate can be directly absorbed by the cathode seal of the second bipolar plate adjacent to the membrane electrode assembly, in particular in the feeding device.

According to one aspect, it is proposed that the electrochemical cell is designed as a fuel cell or as an electrolyzer.

If the electrochemical cell is designed as a fuel cell or as an electrolyzer, this also means that it is designed to be operated both as a fuel cell and as an electrolyzer.

This enables the conversion of chemical energy into electrical energy or the conversion of electrical energy into chemical energy with a corresponding design of the device.

The uninterrupted support of the respective seals can improve the tightness of an electrochemical cell constructed in this way, particularly in a stack of electrochemical cells constructed in this way.

According to one aspect, it is proposed that the anode seal and the cathode seal of the respective bipolar plate are arranged offset from each other in the feeding device of the electrochemical cell so as to enable the feeding of operating media from a respective port connection into a feeding region of the electrochemical cell.

According to one aspect, it is proposed that a cathode side of the first bipolar plate of the electrochemical cell is set up to position and support a cathode seal of the first bipolar plate, and furthermore an anode side of the second bipolar plate is set up to arrange and support an anode seal of the second bipolar plate, so that the cathode seal of the first bipolar plate and the anode seal of the second bipolar plate are arranged opposite one another in a spatially corresponding manner and so that a contact pressure acting on a further membrane electrode assembly, which is arranged between the cathode side of the first bipolar plate and the anode side of the second bipolar plate, is supported without interruption by the anode seal of the second bipolar plate and by the cathode seal of the first bipolar plate in the respective feeding device. Furthermore, the cathode seal of the first bipolar plate can be arranged offset against the anode seal of the first bipolar plate and/or the anode seal of the second bipolar plate can be located offset against the cathode seal (152b) of the second bipolar plate in the direction of the feeding region in such a way that the feeding of operating media by means of the respective bipolar plate is made possible.

Due to the uninterrupted support, an improved sealing of the respective electrochemical cell in such a stack of electrochemical cells can be achieved in a stack of a plurality of alternately arranged first bipolar plates and second bipolar plates.

According to one aspect, it is proposed that the respective anode seal and the respective cathode seal are arranged spatially opposite one another over their respective entire lengthwise extent in the feeding device on the membrane electrode assembly such that a force acting from the anode seal on the membrane electrode assembly is directly absorbed by the cathode seal adjacent to the membrane electrode assembly over an entire width of the anode seal.

By absorbing the force over the entire width [and] the entire length of the feeding device, a better seal of the electrochemical cell can be achieved.

According to one aspect, it is proposed that the anode side of the first bipolar plate of the electrochemical cell is formed by means of an anode electrode board of the first bipolar plate and the cathode side of the first bipolar plate is formed by means of a cathode electrode board of the first bipolar plate, and the cathode side of the second bipolar plate is formed by means of a cathode electrode board of the second bipolar plate and an anode side of the second bipolar plate is formed by means of an anode electrode board of the second bipolar plate. Furthermore, the anode electrode board of the first bipolar plate can have a groove on an outer anode side for accommodating the anode seal and the cathode electrode board of the second bipolar plate can have a groove on an outer cathode side for accommodating the cathode seal.

The outer cathode side or the outer anode side is the respective side of the bipolar plate that faces the membrane electrode assembly.

Because the respective bipolar plates have correspondingly formed electrode boards, the respective bipolar plates are light in weight and easy and economical to manufacture.

The respective grooves of the respective electrode boards can be shaped and/or shaped as a bead in the electrode board.

According to one aspect, it is proposed that the cathode electrode board of the first bipolar plate has a groove on the outer cathode side for accommodating the cathode seal of the first bipolar plate, and the anode electrode board of the second bipolar plate has a groove on an outer anode side for accommodating the anode seal of the second bipolar plate. Furthermore, the groove for accommodating the cathode seal of the first bipolar plate can be arranged offset from the groove for accommodating the anode seal of the first bipolar plate, so that the feeding of operating media into the respective feeding region of the electrochemical cell is made possible and the groove for accommodating the anode seal of the second bipolar plate can be arranged offset from the groove for accommodating the cathode seal of the second bipolar plate, so that the feeding of operating media into the respective feeding region of the electrochemical cell is made possible.

According to one aspect, an electrochemical cell is proposed comprising a feeding device for feeding operating media from a port connection of the electrochemical cell into a feeding region of the electrochemical cell, wherein the feeding device is fluid-coupled to the port connection. Furthermore, the feeding device is formed by a first electrode board and a second electrode board, and the feeding device has at least one feed channel into which a bulge of a bead of the first board and a bulge of a bead of the second board project.

The term bead is to be understood broadly and comprises manually or mechanically produced channel-shaped indentations in sheet metal, boards, cylinders or tubes in order to achieve certain geometric structures or, for example, to increase the rigidity of parts of a structure or an overall arrangement of structures. In particular, the term bead comprises a so-called full bead. Such a bead forms a depression, referred to in this context as a groove, on one side of the base material, such as a sheet or board, into which the bead is molded, and a concave structure, referred to in this context as a bulge, on the other side of the base structure.

The feed channel can be designed to carry the respective operating medium.

The respective operating medium can be introduced into different functional regions of the electrochemical cell, such as a coolant compartment or an electrode compartment, through the feed channel into which the bulge of the bead of the first board and the bulge of the bead of the second board protrude, wherein the respective beads mechanically stabilize and robustly support the structure of the feed channel.

This means that the robust principle of sealing the electrochemical cell with seals, which are supported against the overlapping metal sheets of the bipolar plate, works for the entire bipolar plate with such a feeding device of an electrochemical cell. This means that even in the region of the cooling water feeding as the operating medium, both seals to a membrane electrode assembly can have the same seal height and the cooling water can still be fed through between the plates as the operating medium.

The fluid-coupling of the feeding device to the port connection can comprise a coupling to the entire port connection or only a coupling to a section of the port connection.

According to one aspect, it is proposed that the respective anode seal and/or respective cathode seal is designed to be circumferential around a port connection without a height step.

According to one aspect, it is proposed that a respective groove, or a respective bead, for accommodating the respective anode seal and/or the respective cathode seal for sealing the port connection with respect to the membrane electrode assembly on the respective bipolar plate has an equal depth, in particular groove depth, for accommodating the respective seal.

The seals can each be arranged on a sheet of the bipolar plate or the electrode board, e.g., in a sealing groove. The other sheet of the bipolar plate or electrode board can be formed into a support structure in this region, such as a wave or channel structure. These support structures can transmit the force via the adjacent membrane electrode assembly, particularly in the region of the edge reinforcement of the membrane electrode assembly, into the support structure of the adjacent bipolar plate or board. This point is not sealed, only the force is transmitted. This membrane electrode assembly is sealed at an offset point. According to this principle, the force is divided between two sealing lines and the force can flow in a straight line through the seals and correspondingly offset support structures.

An anode electrode board and the cathode electrode board can together form both a bipolar plate and an electrochemical cell, such as a fuel cell. The anode board and the cathode board can be assigned to one electrochemical cell or to two adjacent electrochemical cells.

The bead of the anode electrode board and the bead of the cathode electrode board of a bipolar plate can each be directed at an angle to a direction from the port connection to a feeding region of the electrochemical cell. The bead of the anode electrode board can be offset against the bead of the cathode electrode board along the direction from the port connection to a feeding region of the electrochemical cell. In particular, the bead of the anode electrode board can be arranged offset from the bead of the cathode electrode board to such an extent that the resulting section of the feed channel does not restrict a clear dimension, such as the width or height, of the feed channel. In other words, this means that the feed channel for feeding operating media to the feeding region of the electrochemical cell is directed at an angle to the orientation of the bead of the first board and the bead of the second board.

In other words, the fluid-coupling of the feeding device to the port connection means that the feeding device is set up so that a fluid such as a liquid or a gas or a mixture of a liquid and a gas can be fed from the port connection into the feeding device and further into the feeding region of the electrochemical cell.

This design of the electrochemical cell with the feeding device removes the restriction that the bipolar plate in the sealing region to the adjacent membrane electrode assembly must always end with a continuous structure, either a seal or a smooth sheet, for sealing to the seal of the next bipolar plate. This results in a smooth, sealable surface towards the next adjacent electrochemical cell with the electrochemical cell constructed according to this description.

The offset arrangement of the bead of the anode electrode board against the bead of the cathode electrode board means that the electrochemical cell can be sealed with seals of constant height despite the presence of the beads. This sealing can take place with the respective seal in a region of the membrane electrode assembly in which the membrane electrode assembly has an edge reinforcement. Such edge reinforcement of the membrane electrode assembly can be provided to improve the sealing of the membrane electrode assembly.

This simplifies the design of an electrochemical cell, makes the application process for the seal robust and is economically advantageous. There are no restrictions with regard to the sealing pattern, as the seal of the port region, for example, can be designed either as a separate circumferential seal around the port regions or as a continuous structure with other seals, e.g., with T-intersections. At the same time, the seal can have a constant cross-section over the entire bipolar plate or board, i.e., no jumps in the height of the seal are necessary.

A further advantage is that the correspondingly large sealing height in combination with the material properties of the sealing material enables good tolerance compensation to be achieved, which increases product reliability and reduces rejects. In particular, different functional regions of the electrochemical cell can be sealed by means of a continuous seal around all port connections and the active surface or as separate seals around the port connections.

The term membrane electrode assembly is to be understood broadly and includes both the membrane electrode assembly itself and a membrane electrode assembly with edge reinforcement.

In particular, the outer region can be understood as the region of the port or the port connection, which is thus sealed against the active surface, for example.

In the solution proposed here, two seals always face each other across the membrane electrode assembly in the electrochemical cell with the feeding device, which is fluid-coupled to a port connection that is provided, for example, for the inflow and outflow of coolant.

However, in an electrochemical cell that provides a feeding device for feeding and removing process media, at least one of the seals can also be replaced by a support structure, since sealing is not necessary there, as will be explained below. In this case, a support structure can also face a seal across the membrane electrode assembly.

In particular, two of the four seals in this structure of the electrochemical cells can alternatively or additionally be replaced by one support structure each, as no sealing is required at these points.

According to one aspect, it is proposed that the feeding device has at least one feed channel into which a bulge of a bead of a first electrode board and a bulge of a bead of a second electrode board protrude.

The anode seal or the cathode seal can be arranged in the respective bead whose bulge protrudes into the feed channel of the feeding device.

In particular, the first bipolar plate can be the same as the second bipolar plate.

In other words, in the electrochemical cell described here, there are always two seals opposite each other across the membrane electrode assembly (MEA) or the edge reinforcement of the membrane electrode assembly for sealing at the relevant point. If no seal is required at the respective point, at least one of the two seals can be replaced by a support structure as described.

The seals rest on the electrode board of the bipolar plate, e.g., in a sealing groove. The other electrode board of the bipolar plate is formed into a support structure in this region, e.g., a wave or channel structure. These support structures transmit the force via the adjacent membrane electrode assembly or an edge reinforcement of the membrane electrode assembly into the support structure of the adjacent bipolar plate. This point is not sealed, only the force is transmitted. The sealing of this MEA is at an offset point.

According to one aspect, it is proposed that the anode electrode board and the cathode electrode board have a plurality of support ribs each oriented at an angle to the direction of the respective bead of the respective board. The support ribs, e.g., in the form of channels, can simultaneously serve both to feed the operating medium from the port into the feeding region of the electrochemical cell and to stabilize the beads. The offset of the beads or seals allows the operating medium to be routed around or under them. The three other sides or other sections of the port can be sealed conventionally with a bead seal or an elastomer seal. Advantageously, the described feeding device of the electrochemical cell can be combined with conventional tunnel solutions for feeding the operating media.

In particular, these support ribs can be formed into the anode electrode board and/or cathode electrode board in the shape of a bead.

Such a support rib can be formed in the respective electrode boards, which are for example in the form of metal sheets, resulting in the advantage of a robust mechanical support of the seal, in particular of structures such as the beads of the adjacent or neighboring boards. These support ribs can have a height or embossing depth that corresponds to the height or embossing depth of the respective beads. These support ribs can be used to provide close-meshed support for an adjacent or neighboring bead and enable the inflow and outflow of operating media thanks to the angled arrangement. In other words, the support ribs are set up to support the bead of the other board.

According to one aspect, it is proposed that in each case two adjacent support ribs of the plurality of support ribs have a mutual spacing in order to feed the operating media to the feeding region of the electrochemical cell via the port connection.

This achieves both the advantage of a constant sealing height for an electrode board, as the corresponding beads of the respective electrode board can have a uniform depth, and a mechanically robust support of the beads due to the large number of elongated structures. The support ribs can form a feed channel in which the operating media are fed to the feeding region of the electrochemical cell in order to fluid-couple the feeding device and the port connection.

According to one aspect, it is proposed that the plurality of support ribs are shaped as beads in the respective electrode boards.

In other words, this means that the beads in the respective electrode boards are mechanically stabilized with the support ribs, which are formed into the respective electrode board and can also support the beads of the respective adjacent and adjoining beads in a stack of electrochemical cells. The fact that the support ribs are embossed and shaped like beads in the respective electrode board results in economical production.

According to one aspect, it is proposed that the plurality of support ribs are arranged in parallel at regular intervals.

This achieves uniform stabilization of the electrode board and the respective bead formed in the electrode board and provides support for the beads of adjacent electrode boards.

According to one aspect, it is proposed that at least a part of the support ribs of the anode electrode board and/or cathode electrode board has at least a section which reduces a mechanical coupling of the support ribs from the respective adjacent bead of the same electrode board in order to improve a spring effect of the respective bead.

Advantageously, such a section, which improves a spring effect, can prevent a hard stop in the support ribs when pressing a stack or a stack of electrochemical cells constructed in this way, for example by the support ribs ending before the flank of the sealing groove, so that a resilient element results, since the stiffening to the groove is eliminated. In this way, a stack of electrochemical cells, such as fuel cells, can be post-compressed, as the two sealing lines are no longer directly coupled. The resulting flanks of the part of the support ribs with spring effect can enable a certain spring effect in each bipolar plate, so that the bipolar plate or a stack of electrochemical cells can be repressed, even during operation of the electrochemical cells, if there are subsidence phenomena or relaxation processes, e.g., caused by a gas diffusion layer of the membrane electrode assembly.

According to one aspect, it is proposed that the first bipolar plate and the second bipolar plate each have a first port connection and a second port connection, and the respective bipolar plates are set up to form a fuel cell stack by alternately stacking corresponding bipolar plates of one type of the first bipolar plate and one type of the second bipolar plate, wherein the first port connection of the first bipolar plate and the second port connection of the first bipolar plate are fluid-coupled to a first feeding device. The first port connection of the second bipolar plate and the second port connection of the second bipolar plate can be fluid-coupled to a second feeding device.

The first feeding device can differ from the second feeding device in the arrangement of the seals or the beads or grooves into which the seals can be inserted.

According to one aspect, it is proposed that the first bipolar plate and the second bipolar plate are of the same design, and the bipolar plate of the same design is set up to form a fuel cell stack by stacking bipolar plates of the same design rotated by 180°, respectively. A first port connection of the identically designed bipolar plate can be fluid-coupled to the first feeding device and a second port connection of the identically designed bipolar plate can be fluid-coupled to the second feeding device.

Stacking rotated by 180° can be understood to mean that the respective bipolar plate is rotated at an angle of 180° about a vertically aligned axis on the respective bipolar plate of the same design before it is stacked on the rotated bipolar plate.

Thus, a stack, or a fuel cell stack, of electrochemical cells with the described feeding devices can also be constructed with only one type of electrode board with different shapes to form the respective port connections, in particular with corresponding feeding devices for the anode board and the cathode board.

For this purpose, the respective board for the construction of a bipolar plate, for example, has two different shapes for forming the respective port connections with the corresponding feeding devices described.

The course of the bead of the feeding device for a first port connection of such asymmetrical electrode boards has a course in which the bead is shifted in one direction towards the feeding region of the electrochemical cell. The course of the corrugation of the feeding device for a second port connection of the asymmetrical board has a course in which the corrugation is shifted in the opposite direction to the feeding region of the electrochemical cell compared to the first port connection.

This spatial displacement results in the two beads interacting in such a way that they form the described feeding device when the boards are arranged accordingly to form an electrochemical cell or an electrochemical stack. In other words, the second port connection results in a narrower port connection than the first port connection. For an arrangement in a stack, the boards or bipolar plates are then each rotated by 180° in the plane of the board.

According to this aspect, two different boards can be stamped for the anode board and the cathode board of the electrochemical cell, respectively, which have the correspondingly offset beads and, if necessary, support ribs. The respective beads can accommodate the seals, which are correspondingly supported on opposite sides of the membrane electrode assembly. For the electrode boards, this results in four different designs for a stack of electrochemical cells, for example, in order to build at least two different bipolar plates, which can be arranged alternately to form a stack. The two other designs result from a different design of the active region of the anode and cathode board.

According to one aspect, it is proposed that in the first feeding device described above, the groove in the cathode electrode board of the respective bipolar plate for accommodating the cathode seal is opposed to the groove in the anode electrode board of the respective bipolar plate for accommodating the anode seal,
is arranged offset in the direction of the port connection, so that, in particular when the bipolar plates are constructed from electrode boards, the feed of operating media to the respective feeding region of the electrochemical cell is made possible.

According to one aspect, it is proposed that in the second feeding device described above, the groove in the cathode electrode board of the respective bipolar plate for accommodating the cathode seal is arranged offset against the groove in the anode electrode board of the respective bipolar plate for accommodating the anode seal, opposite to the direction of the port connection, so that, in particular when the bipolar plates are constructed from electrode boards, the feeding of operating media into the respective feeding region of the electrochemical cell (100) is enabled.

According to one aspect, it is proposed that for feeding an operating medium into an anode compartment or a cathode compartment of the electrochemical cell, the anode electrode board and/or the cathode electrode board of the first bipolar plate (101) and/or the second bipolar plate has a fluid-passing opening in the feeding device.

The fluid-passing opening in the respective electrode board can be arranged in such a way that a fluid can pass from one side of the board to the other (rear) side of the board.

Advantageously, the design principle with offset seals or offset beads also allows the process media, such as process gases, to be fed to or removed from the electrochemical cell. Additional apertures or openings in the respective board or sheet allow access to the process chambers or membrane electrode assemblies of the electrochemical cell on the corresponding rear sides of the boards. In particular, a bead groove for welding the two panel halves can be adjacent to the support structures.

The bead with the opening for accommodating the seal can be made wider in order to provide sufficient space for such an opening next to a contact surface for the seal. A corresponding internal pressure of the electrochemical cell during operation of the electrochemical cell means that the seal cannot close the opening.

A stack of electrochemical cells formed by means of bipolar plates of the first bipolar plate type and the second bipolar plate type or of the same bipolar plate type as described above is proposed.

Such a stack of electrochemical cells has a plurality of electrochemical cells arranged in layers adjacent to or on top of each other, for example to generate high voltages, especially in a small space.

A use of one of the electrochemical cells as described above or a stack of electrochemical cells as described above is proposed for operating a mobile platform.

By using such an electrochemical cell or a stack of such electrochemical cells, a drive for a mobile platform can be realized cost-effectively.

A mobile platform can be an at least partially automated system that is mobile and/or a driver assistance system. An example can be an at least partially automated vehicle or a vehicle comprising a driver assistance system. In other words, in this context, an at least partially automated system includes a mobile platform in terms of an at least partially automated functionality, but a mobile platform also includes vehicles and other mobile machines including driver assistance systems. Other examples of mobile platforms can be driver assistance systems with multiple sensors, mobile multi-sensor robots such as robot vacuum cleaners or lawn mowers, a multi-sensor monitoring system, a manufacturing machine, an airplane, a ship, a drone, a personal assistant or an access control system. Each of these systems can be a fully or partially autonomous system.

### BRIEF DESCRIPTION OF THE DRAWINGS

In the following, exemplary embodiments of the invention are explained in more detail with reference to FIGS. 1 through 10. The figures show the following:

FIG. 1 an outline of a cross-section of electrochemical cells with feeding devices;

FIG. 2a an isometric outline of a feeding device for a first bipolar plate and a feeding device for a second bipolar plate of an electrochemical cell;

FIG. 2b a stack of bipolar plates with membrane electrode assemblies;

FIG. 3 a isometric outline of an electrode board with beads or grooves for forming a feeding device;

FIG. 4 an outline of a cross-section of a feeding device for bipolar plates of an electrochemical cell;

FIG. 5 an outline of a cross-section of feeding devices of an electrochemical cell including cooling device with sections of support ribs for decoupling;

FIG. 6 an outline of a cross-section of feeding devices for feeding process media to the membrane electrode assembly of an electrochemical cell;

FIG. 7 an outline of a cross-section of feeding devices for feeding process media to the membrane electrode assembly of an electrochemical cell with support structure;

FIG. 8a an outline of a top view of an electrode board of a bipolar plate with two identically shaped port connections of a first type;

FIG. 8b an outline of a top view of an electrode board of a bipolar plate with two identically shaped port connections of a second type;

FIG. 9a an outline of a top view of an electrode board of a bipolar plate with two differently shaped port connections; and

FIG. 9b an outline of a top view of an electrode board of a bipolar plate with two differently shaped port connections rotated 180°.

FIG. 10 an outline of a top view of an electrode board of a bipolar plate with two differently shaped port connections, which are outlined in enlarged isometric form.

### DETAILED DESCRIPTION

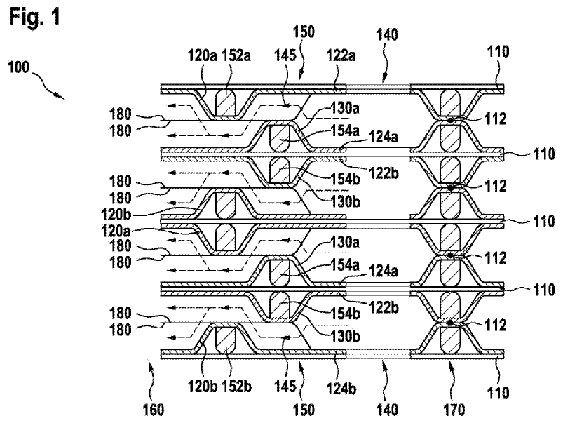

FIG. 1 outlines a cross-section of an electrochemical cell 100 with feeding devices 150 for feeding coolant from a port connection 140 of the electrochemical cell 100 into a feeding region 160 of the electrochemical cell 100.

In addition, at least parts of adjacent electrochemical cells are outlined in FIG. 1 to indicate a periodicity of the structures of elements of stacked electrochemical cells.

The feeding device 150 is fluid-coupled to the port connection 140. That is, the electrochemical cell is set up with the feeding device 150 to feed coolant from a port of a stack of electrochemical cells, which is formed by a plurality of port connections 140, by means of the port connection 140 through the feeding device 150 into the feeding region 160 of the electrochemical cell in accordance with the flow direction 145.

In the following, the feeding device 150 is explained according to the upper part of the cross-section of the electrochemical cell of FIG. 1, since the lower part of the cross-section repeats the corresponding structure in mirror image.

This feeding device 150 of a first bipolar plate 101 is formed by a cathode electrode board 122a and an anode electrode board 124a, wherein the feeding device 150 has at least one feed channel into which a bulge of the bead 120a of the cathode electrode board 122a and a bulge of the bead 130a of the anode electrode board 124a protrude. The respective bead represents the shape of a groove on one side or a bulge on the other side of the respective electrode board.

The bead 120a of the cathode electrode board 122a is arranged offset from the bead 130a of the anode electrode board 124a, so as to enable the coolant to be fed from the port connection 140 to the feeding region 160 of the electrochemical cell 100 in accordance with the indicated flow direction 145.

In this exemplary embodiment, the bead 120a of the cathode electrode board 122a of the first bipolar plate 101 and the bead 130a of the anode electrode board 124a of the first bipolar plate 101 form a substantially right angle to a direction from the port connection 140 to the feeding region 160 of the electrochemical cell 100. The offset of the bead 120a of the cathode electrode board 122a from the bead 130a of the anode electrode board 124a along the direction from the port connection 140 to a feeding region 160 of the electrochemical cell 100 is such that a clear dimension, such as the width or the height, of the feed channel is not restricted by the resulting portion of the feed channel.

The bead 120a of the cathode electrode board 122a and the bead 130a of the anode electrode board 124a are set up to accommodate a seal 152a, 154a in a groove resulting from the respective bead 120a, 130a on the side of the respective board 122a, 124a opposite to the feed channel, which can seal an inner region of the electrochemical cell 100, by contacting a membrane electrode assembly 110 of the electrochemical cell 100, against an outer region, such as the region of the port connection 140, of the electrochemical cell 100. Thus, due to the offset arrangement of the bead 120a of the cathode electrode board 122a against the bead 130a of the anode electrode board 124a, it can be achieved that despite the existing beads 120a, 130a, the bulge of which protrudes into the feed channel, the electrochemical cell 100 can be sealed with seals 152a, 154a of constant height supported by the respective electrode board without interruption.

The anode electrode board 124a is therein set up to position an anode seal 154a and to support it without interruption in the respective feeding device 150, and the cathode electrode board 122a is set up to position the cathode seal 152a and to support it without interruption in the respective feeding device 150.

Here, the anode electrode board of the first bipolar plate 124a may be set up to seal a membrane electrode assembly 110 arranged between the first bipolar plate 101 and a second bipolar plate 102 by means of the anode seal 154a arranged on an anode side of the first bipolar plate, thus arranged on the anode electrode board 124a of the first bipolar plate 101, with respect to the first bipolar plate 101.

In this case, the feeding device of the second bipolar plate 150 may be set up to seal the membrane electrode assembly 110 with respect to the second bipolar plate 102 by means of a cathode seal 154b on a cathode side of the second bipolar plate, i.e., arranged on the cathode electrode board 122 b of the second bipolar plate 102.

And the anode electrode board 124a of the first bipolar plate 101 may be set up to position and support the anode seal 154a, and the cathode electrode board 122b of the second bipolar plate 102 may be set up to position and support the cathode seal 154b, so that the anode seal 154a and the cathode seal 154b are arranged opposite to each other in a spatially corresponding manner, and that a contact pressure acting on the membrane electrode assembly 110, which results in particular in the mounted state of the first bipolar plate 101 with the second bipolar plate 102, is supported by the anode seal 154a and by the cathode seal 154b in the respective feeding device 150 without interruption.

It can be seen in FIG. 1 that the groove, or bead, 120a of the cathode electrode board of the first bipolar plate 122a and the groove, or bead, 130a of the anode electrode board of the first bipolar plate 124a are set up to accommodate seals 152a, 154a in such a way that they each interact with a corresponding seal 152b, 154a of a further bipolar plate on the respective opposite side of the membrane electrode assembly 110 in such a way that corresponding seals 152a,b; 154a,b are supported against each other opposite the respective membrane electrode assembly 110.

A cathode side of the first bipolar plate 110 of the electrochemical cell 100 may be set up with a cathode electrode board 122a to position and support a cathode seal 152a of the first bipolar plate 101. An anode side of the second bipolar plate 102 may be set up with an anode electrode board 124b to position and support an anode seal 152b of the second bipolar plate 102, so that the cathode seal 152a of the first bipolar plate 101 and the anode seal 152b of the second bipolar plate 102 are arranged opposite to each other in a spatially corresponding manner, and that a contact pressure acting on a further membrane electrode assembly, which is arranged between the cathode side of the first bipolar plate and the anode side of the second bipolar plate, is supported without interruption by the anode seal 152b of the second bipolar plate 102 and by the cathode seal 152a of the first bipolar plate 101 in the respective feeding device 150. Further, the cathode seal 152a of the first bipolar plate 101 may be arranged offset from the anode seal 154a of the first bipolar plate 101 and/or the anode seal 152b of the second bipolar plate 102 may be arranged offset from the cathode seal 154b of the second bipolar plate 102 in the direction of the feeding region 160 such that the feeding of operating media by means of the respective bipolar plate is enabled.

This structure of the feeding device 150 of the electrochemical cell 100 means that there are always two seals, such as seals 154a, 154b, facing each other via the membrane electrode assembly 110. The same applies to the other seals of the electrochemical cell 100 in the region of the feeding device 150 if the cross-section of the electrochemical cell 100 shown in FIG. 1 is arranged in a stack of electrochemical cells 100 one above the other.

A plurality of support ribs 180, each aligned at an angle to the direction of a respective extension of the bead 120a, 130a in the respective electrode board, are indicated by thin lines in FIG. 1. The support ribs, e.g., in the form of channels, simultaneously serve to feed the coolant from the port via the port connection 140 into the feeding region 160 of the electrochemical cell 100 and to stabilize the respective adjacent beads 120a, 130a. This plurality of support ribs 180 may be formed into the cathode electrode board 122a and the anode electrode board 124a in a bead-like manner and stabilize the offset beads 120a, 130a.

On the side of the port 140 opposite the feeding region 160 of the electrochemical cell 100, the electrochemical cell 100 may be sealed by a corresponding arrangement of beads and seals in the outer region of the electrochemical cell 170 and/or may be sealed by bonding and/or welding the adjacent boards together at a location 112.

In FIGS. 1 through 7, the region of the ports and feeding devices 150 of the respective bipolar plates with the corresponding electrode boards is always shown in such a way that both electrode boards have the same embossing depth. They therefore touch at half the height of the bipolar plate (contact plane), which means that the seals on the anode and cathode side can have the same height. In general, the depth of embossing can vary. Then seals on one side of the electrochemical cell still have a uniform height and the seal height of the anode side can differ from the cathode side of the respective bipolar plate, as the channel structures in the active region of the cell on the anode side are often different from the cathode side and therefore have different embossing depths. The cathode side can be embossed deeper, as the volume flow in air operation is greater than on the anode. The position of a contact plane created in this way can be selected in the active region of the electrochemical cell independently of that in the port region.

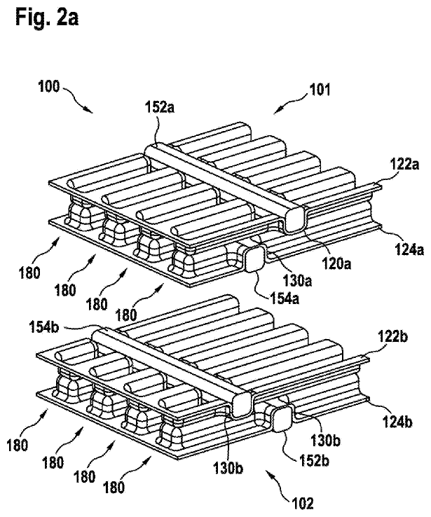

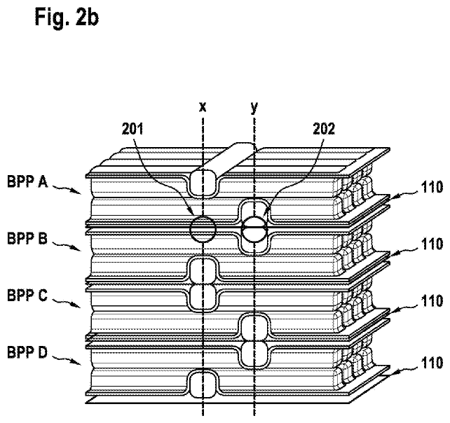

The representation of FIG. 2 a outlines the feeding device 150 for coolant to a first bipolar plate 101 and the feeding device to a second bipolar plate 102 of an electrochemical cell 100 corresponding to the cross-section of FIG. 1 as an isometric outline, in which the membrane electrode assemblies 110 have not been reproduced. Identical reference signs describe the same features of the respective electrode boards.

FIG. 2b outlines an isometric representation of a stack of bipolar plates BPP A, BPP B, BPP C, BPP D with membrane electrode assemblies 110 arranged between them. Here, the lines of force x and y outline how a contact pressure, which is generated and/or built up by the assembly of a stack of electrochemical cells, is supported without interruption by the respective anode seal and the respective cathode seal, the respective bipolar plates, which are arranged in a spatially corresponding manner on the two sides of the membrane electrode assembly 202, in the respective grooves which accommodate the respective seals. To transmit the force in lines x and y, the spatially corresponding seals alternate in the direction of the force with the support ribs, which also correspond to each other 201.

In the region shown, the arrangement of the seals differs, particularly in the feeding device of the bipolar plates BPP A and BPP B. This arrangement of the seals is repeated for the bipolar plates BPP C (corresponds to A) and BPP D (corresponds to B).

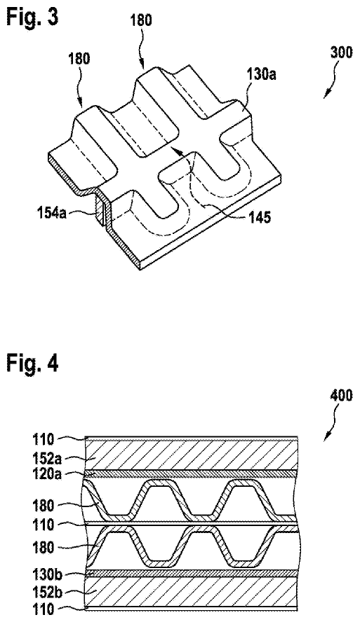

The illustration of FIG. 3 is an isometric outline of the anode electrode board 124a from a different perspective for forming a feeding device 150 according to FIGS. 1 and 2. The arrow 145 indicates a possible flow direction of the coolant or operating medium.

FIG. 4 outlines a cross-section of the feeding device 150 for the first bipolar plate 101 and the second bipolar plate 102 of the electrochemical cell 100 in the longitudinal direction of the center of the seals 152a, 152b according to, for example, FIG. 2. In particular, the mechanical support effect of the support ribs 180 for the beads 120a and 130b can be seen.

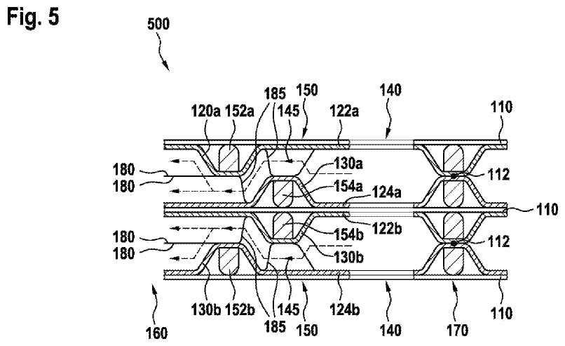

FIG. 5 outlines a cross-section of feeding devices 150 of an electrochemical cell 100 for feeding coolant to the bipolar plates of the electrochemical cell 100, wherein the support ribs 180 of the first and/or second board have at least a section 185 which reduces a mechanical coupling of the support ribs 180 from the respective adjacent bead 120a,b, 130a,b of the same board in order to improve a spring effect of the respective bead 120a,b, 130a,b.

For this purpose, the support ribs 180 end in front of the flank of the sealing groove or the bead 120a, 130a, so that a resilient element results, since the stiffening to the groove or bead 120a, 130a is eliminated.

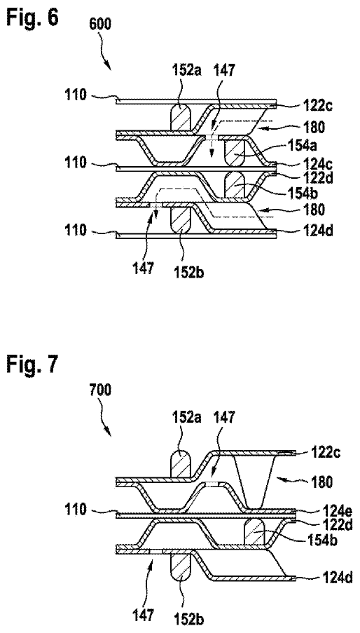

FIG. 6 outlines a cross-section of a feeding device 150 for feeding process media to the membrane electrode assembly 110 of an electrochemical cell 100. The structure corresponds to the description of FIG. 1 with a cathode electrode board 122c of the first bipolar plate, a cathode electrode board 122d of the second bipolar plate and an anode electrode board 124c of the first bipolar plate, with the difference that the anode electrode board 124c of the first bipolar plate and the anode electrode board of the second bipolar plate 124d have an opening 147 through which fluid can pass for feeding process media.

The offset corrugations with the offset anode seal of the first bipolar plate 152a against the cathode seal of the first bipolar plate 154a allow the process media, such as process gases, to be fed to or removed from the electrochemical cell 100. For this purpose, the bead with the opening 147 for accommodating the seal 154a and 152b is wider in order to provide sufficient space for such an opening 147 next to a contact surface for the seal 154a and 152b.

FIG. 7 outlines a cross-section of feeding devices 150 for feeding process media to the membrane electrode assembly 110 of an electrochemical cell 100 with a support structure corresponding to a deeper embossed support rib 180 in which one of the four seals 152a, 154a, 154b, 152b in this structure of the electrochemical cell 100 is replaced by a modified support rib 180 as support structure compared to the previous exemplary embodiment, since accordingly no sealing is required at this point.

In FIG. 7, only one seal is replaced by a support structure. In principle, however, the seal 152b can also be replaced by a support structure.

This modified support structure 180 takes over the supporting effect of the replaced seal 154a, as outlined in FIG. 6. By modifying the support structure, seal 152b can also be replaced in the same way.

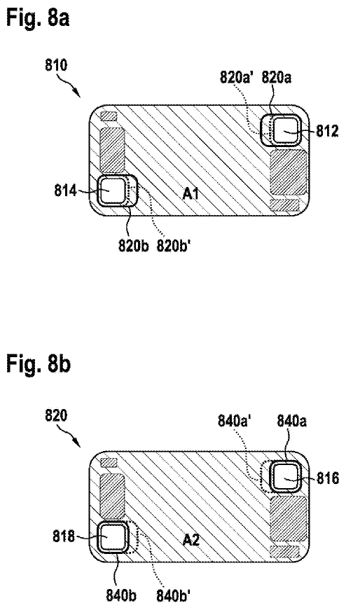

FIG. 8a outlines a top view of a first bipolar plate 810, which is formed of an anode electrode board and a cathode electrode board and has two identically shaped port connections 812, 814 of a first type. In the top view of the bipolar plate 810, a top view of the anode electrode board is outlined. A first port connection 812 and a second port connection 814 of the bipolar plate 810 are fluid-coupled to a first feeding device of the electrochemical cell. In this first feeding device, the seal 820a of the anode electrode board is configured to completely surround the first port connection 812 and the second port connection 814 to seal the anode electrode board from a membrane electrode assembly adjacent to the anode electrode board. In this case, this first feeding device is designed such that the anode seal 820a in the feeding device of the electrochemical cell is arranged offset in the direction of the feeding region of the electrochemical cell, so that the feeding of the operating media into the feeding region is enabled. The corresponding cathode seal 820a′ and 820b′ of the cathode electrode board, which is arranged offset from the anode seal, is indicated by a dotted line.

FIG. 8b outlines a top view of a second bipolar plate 820 formed of an anode electrode board and a cathode electrode board and having two identically shaped port connections 812, 814 of a second type. In the top view of the bipolar plate 820, a top view of the anode electrode board is outlined. A first port connection 816 and a second port connection 818 of the bipolar plate 810 are fluid-coupled to a second feeding device of the electrochemical cell. In this second feeding device, the respective seal 840a of the anode electrode board is configured to completely surround the first port connection 816 and the second port connection 818 of the second bipolar plate 820 to seal the anode electrode board from a membrane electrode assembly adjacent to the anode electrode board. In this case, this second feeding device is designed such that the anode seal 840a in the feeding device of the electrochemical cell is arranged offset from the cathode seal of the second bipolar plate 820 in the opposite direction to the feeding region of the electrochemical cell, so that the feeding of the operating media into the feeding region is enabled. The corresponding cathode seal 840a′ and 840b′ of the cathode electrode board, which is arranged offset from the anode seal, is indicated by a dotted line.

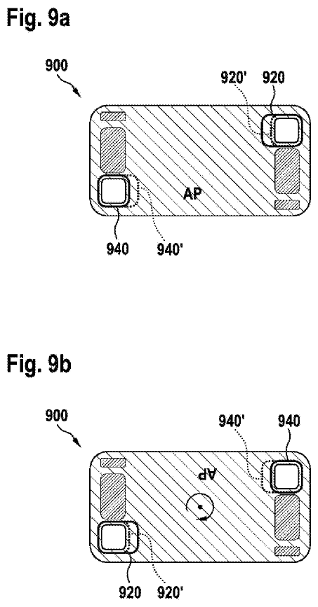

FIG. 9a outlines a top view of a bipolar plate, wherein the bipolar plate is formed of an anode electrode board and a cathode electrode board and has two unequally shaped port connections 916, 918 of a first and a second type. The top view of the bipolar plate 900 outlines a top view of the anode electrode board. A first port connection 916 and a second port connection 918 of the bipolar plate 900 are fluid-coupled to a first feeding device and a second feeding device of the electrochemical cell, respectively.

In the first feeding device, the respective seal 920 of the anode electrode board is configured to completely surround the first port connection 916 to seal the anode electrode board from a membrane electrode assembly adjacent to the anode electrode board at the first port connection 916. In this case, this first feeding device is designed such that the anode seal 920 in the feeding device of the electrochemical cell is arranged offset in the direction of the feeding region of the electrochemical cell, so that the feeding of the operating media into the feeding region is enabled. The corresponding cathode seal 920′ of the cathode electrode board of the first port connection 916, which is arranged offset relative to the anode seal, is indicated by a dotted line.

In the second feeding device, the second port connection 918, the respective seal 940 of the anode electrode board is configured to completely surround the second port connection 918 to seal the anode electrode board from a membrane electrode assembly adjacent to the anode electrode board at the second port connection 918. In this case, this second feeding device is designed such that the anode seal 940 in the feeding device of the electrochemical cell is arranged offset from the cathode seal of the cathode electrode board in the opposite direction to the feeding region of the electrochemical cell, so that the feeding of operating media into the feeding region is made possible. The corresponding cathode seal 940′ of the cathode electrode board of the second port connection 918, which is arranged offset relative to the anode seal, is indicated by a dotted line.

FIG. 9b outlines a top view of the bipolar plate with two differently shaped port connections corresponding to FIG. 9a, which is rotated by 180° compared to the representation in FIG. 9a in order to be able to form a fuel cell stack by alternately arranging bipolar plates each rotated by 180° with two differently shaped port connections.

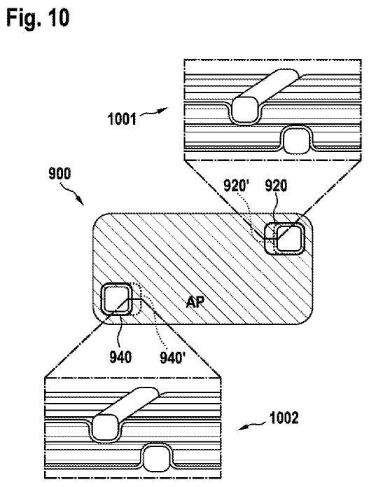

FIG. 10 outlines a top view of the bipolar plate with two differently shaped port connections as shown in FIG. 9a, outlining in isometric sections the arrangement of the offset anode seal relative to the cathode seal in the feeding device with the respective electrode boards through the cutout 1001 for the first port connection and through the cutout 1002 for the second port connection.

1. An electrochemical cell (100) comprising
a first bipolar plate (101);
a second bipolar plate (102); wherein
the first bipolar plate (101) and the second bipolar plate (102) each have a feeding device (150) for feeding operating media from a port connection (140) of the bipolar plate into a feeding region (160) of the respective bipolar plate; and
the feeding device of the first bipolar plate (150) is configured to seal a membrane electrode assembly (110), which is arranged between the first bipolar plate (101) and the second bipolar plate (102), with respect to the first bipolar plate (101) by an anode seal (154a) arranged on an anode side of the first bipolar plate, and
the feeding device of the second bipolar plate (150) is configured to seal the membrane electrode assembly (110) with respect to the second bipolar plate (102) by a cathode seal (154b) on a cathode side of the second bipolar plate; wherein
the anode side of the first bipolar plate is configured to position and support the anode seal (154a); and the cathode side of the second bipolar plate is configured to position and support the cathode seal (154b); wherein the anode seal and the cathode seal are arranged in a spatially corresponding manner opposite each other, and a contact pressure acting on the membrane electrode assembly (110) is supported by the anode seal (154a) and by the cathode seal (154b) in the feeding device (150) without interruption.

2. The electrochemical cell according to claim 1, wherein
a cathode side of the first bipolar plate is configured to position and support a cathode seal (152a) of the first bipolar plate; and
an anode side of the second bipolar plate is configured to position and support an anode seal (152b) of the second bipolar plate, wherein the cathode seal (152a) of the first bipolar plate and the anode seal (152b) of the second bipolar plate are arranged spatially correspondingly opposite one another, and that a contact pressure acting on a further membrane electrode assembly (110), which is arranged between the cathode side of the first bipolar plate and the anode side of the second bipolar plate, is supported by the anode seal (152b) of the second bipolar plate and by the cathode seal (152a) of the first bipolar plate without interruption in the respective feeding device; and wherein the cathode seal (152a) of the first bipolar plate is arranged offset against the anode seal (154a) of the first bipolar plate and/or the anode seal (152b) of the second bipolar plate is arranged offset against the cathode seal (154b) of the second bipolar plate in a direction of the feeding region so that the feeding of operating media is made possible by the respective bipolar plate.

3. The electrochemical cell according to claim 2, wherein the respective anode seal (154a, 152b) and the respective cathode seal (154b, 152a) are arranged spatially correspondingly opposite one another over their respective entire lengthwise extension in the feeding device (150) on the membrane electrode assembly (110) in such a way that a force acting on the membrane electrode assembly from the anode seal (154a, 152b) is directly absorbed by the cathode seal (154b, 152a) arranged correspondingly on the membrane electrode assembly (110) over an entire width of the anode seal (154a, 152b).

4. The electrochemical cell (100) according to claim 2, wherein
the anode side of the first bipolar plate is formed by an anode electrode board of the first bipolar plate (124a) and the cathode side of the first bipolar plate is formed by a cathode electrode board of the first bipolar plate (122a); and
the cathode side of the second bipolar plate is formed by a cathode electrode board of the second bipolar plate (122b) and the anode side of the second bipolar plate is formed by an anode electrode board of the second bipolar plate (124b); and
the anode electrode board of the first bipolar plate (124a) has a groove (130a) on an outer anode side for accommodating the anode seal (154a); and
the cathode electrode board of the second bipolar plate (122b) has a groove (130b) on an outer cathode side for accommodating the cathode seal (154b).

5. The electrochemical cell according to claim 4, wherein
the cathode electrode board of the first bipolar plate (122a) has a groove (120a) on the outer cathode side for accommodating the cathode seal of the first bipolar plate (152a), and
the anode electrode board of the second bipolar plate (124b) has a groove (120b) on an outer anode side for accommodating the anode seal of the second bipolar plate (152b); and
the groove (120a) for accommodating the cathode seal of the first bipolar plate (152a) is arranged offset against the groove (130a) for accommodating the anode seal of the first bipolar plate (154a) so as to allow the feeding of operating media to the respective feeding region (160) of the electrochemical cell (100); and
the groove (120b) for accommodating the anode seal of the second bipolar plate (152b) is arranged offset against the groove (130b) for accommodating the cathode seal of the second bipolar plate (154b) so that the feeding of operating media into the respective feeding region (160) of the electrochemical cell (100) is made possible.

6. The electrochemical cell (100) according to claim 1, wherein the first bipolar plate (101) and the second bipolar plate (102) each have a first port connection (812, 816) and a second port connection (814, 818); and are configured to form a fuel cell stack by alternately stacking corresponding bipolar plates of one type of the first bipolar plate and one type of the second bipolar plate; wherein the first port connection (812) of the first bipolar plate and the second port connection (814) of the first bipolar plate are fluid-coupled to a first feeding device; and the first port connection of the second bipolar plate (816) and the second port connection of the second bipolar plate (818) are fluid-coupled to a second feeding device.

7. The electrochemical cell (100) according to claim 1, wherein the first bipolar plate and the second bipolar plate are of a same design and configured to form a fuel cell stack by stacking bipolar plates of the same design rotated 180°, respectively; wherein a first port connection (916) of one identically configured bipolar plate is fluid-coupled to the first feeding device; and a second port connection (918) of the identically configured bipolar plate is fluid-coupled to the feeding device.

8. The electrochemical cell (100) according to claim 4, wherein in a first feeding device,
the groove in the cathode electrode board of the respective bipolar plate for accommodating the cathode seal is arranged offset against the groove in the anode electrode board of the respective bipolar plate to accommodate the anode seal, in a direction of the port connection, so that the feeding of operating media into the respective feeding region (160) of the electrochemical cell (100) is made possible.

9. The electrochemical cell (100) according to claim 4, wherein in a second feeding device,
the groove in the cathode electrode board of the respective bipolar plate for accommodating the cathode seal is arranged offset against the groove in the anode electrode board of the respective bipolar plate to accommodate the anode seal, against a direction of the port connection, so that the feeding of operating media into the respective feeding region (160) of the electrochemical cell (100) is made possible.

10. The electrochemical cell (100) according to claim 4, wherein for feeding an operating medium into an anode space or a cathode space of the electrochemical cell (100, 200), the anode electrode board and/or the cathode electrode board of the first bipolar plate (101) and/or the second bipolar plate (102) comprises a fluid-passing opening (147) in the feeding device.

11. A stack of electrochemical cells formed by bipolar plates of a first bipolar plate type and a second bipolar plate type and/or a same type of bipolar plate according to claim 1.

12. A mobile platform having an electrochemical cell (100, 200) according to claim 1.

13. The electrochemical cell (100) according to claim 5, wherein in a first feeding device, the groove in the cathode electrode board of the respective bipolar plate for accommodating the cathode seal is arranged offset against the groove in the anode electrode board of the respective bipolar plate to accommodate the anode seal, in a direction of the port connection, so that the feeding of operating media into the respective feeding region (160) of the electrochemical cell (100) is made possible.

14. The electrochemical cell (100) according to claim 5, wherein in a second feeding device, the groove in the cathode electrode board of the respective bipolar plate for accommodating the cathode seal is arranged offset against the groove in the anode electrode board of the respective bipolar plate to accommodate the anode seal, against a direction of the port connection, so that the feeding of operating media into the respective feeding region (160) of the electrochemical cell (100) is made possible.

15. A mobile platform having a stack of electrochemical cells (100, 200) according to claim 11.
